(19) United States
(12) Patent Application Publication
(10) Pub. No.: US 2012/0001567 A1
(43) Pub. Date: Jan. 5, 2012

(54) Lighting Control System

(75) Inventors: David J. Knapp, Austin, TX (US); Horace C. Ho, Austin, TX (US); Jason Lewis, Driftwood, TX (US)

(73) Assignee: FIREFLY GREEN TECHNOLOGIES, INC., Austin, TX (US)

(21) Appl. No.: 13/231,077

(22) Filed: Sep. 13, 2011

Related U.S. Application Data
(63) Continuation-in-part of application No. 12/924,628, filed on Sep. 30, 2010.
(60) Provisional application No. 61/277,871, filed on Sep. 30, 2009.
(60) Provisional application No. 61/281,046, filed on Nov. 12, 2009.
(60) Provisional application No. 61/336,242, filed on Jan. 19, 2010.
(60) Provisional application No. 61/339,273, filed on Mar. 2, 2010.

(51) Int. Cl. H05B 37/02

(52) U.S. Cl. 315/291

(57) ABSTRACT

Intelligent illumination device are disclosed that use components in an LED light to perform one or more of a wide variety of desirable lighting functions for very low cost. The LEDs that produce light can be periodically turned off momentarily, for example, for a duration that the human eye cannot perceive, in order for the light to receive commands optically. The optically transmitted commands can be sent to the light, for example, using a remove control device. The illumination device can use the LEDs that are currently off to receive the data and then configure the light accordingly, or to measure light. Such light can be ambient light for a photosensor function, or light from other LEDs in the illumination device to adjust the color mix.

### PRIORITY CLAIM

The present application is a continuation-in part of U.S. patent application Ser. No. 12/924,628 filed Sep. 30, 2010 which claims priority to the following: (1) U.S. Provisional Patent Application No. 61/277,871 filed Sep. 30, 2009; (2) U.S. Provisional Patent Application No. 61/281,046 filed Nov. 12, 2009; (3) U.S. Provisional Patent Application No. 61/336,242 filed Jan. 19, 2010; (4) U.S. Provisional Patent Application No. 61/339,273 filed Mar. 2, 2010; which is further a continuation-in-part of U.S. patent application Ser. Nos. 12/806,114; 12/806,117; 12/806,121; 12/806,118; 12/806,126; 12/806,113, all filed Aug. 5, 2010, all of which claim priority to: (1) U.S. Provisional Patent Application No. 61/273,518 filed Aug. 5, 2009; (2) U.S. Provisional Patent Application No. 61/273,536 filed Aug. 5, 2009; (3) U.S. Provisional Patent Application No. 61/277,871 filed Sep. 30, 2009; (4) U.S. Provisional Patent Application No. 61/281,046 filed Nov. 12, 2009; (5) U.S. Provisional Patent Application No. 61/336,242 filed Jan. 19, 2010; (6) U.S. Provisional Patent Application No. 61/339,273 filed Mar. 2, 2010; all of which are further continuations-in-part of U.S. patent application Ser. No. 12/803,805 filed Jul. 7, 2010 which claims priority to: (1) U.S. Provisional Patent Application No. 61/224,904 filed Jul. 12, 2009; (2) U.S. Provisional Patent Application No. 61/273,518 filed Aug. 5, 2009; (3) U.S. Provisional Patent Application No. 61/273,536 filed Aug. 5, 2009; (4) U.S. Provisional Patent Application No. 61/277,871 filed Sep. 30, 2009; (5) U.S. Provisional Patent Application No. 61/281,046 filed Nov. 12, 2009; (6) U.S. Provisional Patent Application No. 61/336,242 filed Jan. 19, 2010; (7) U.S. Provisional Patent Application No. 61/339,273 filed Mar. 2, 2010; which further is a continuation-in-part of U.S. patent application Ser. No. 12/360,467 filed Jan. 27, 2009; and which further is a continuation-in-part of U.S. patent application Ser. No. 12/584,143 filed Sep. 1, 2009 which claims priority to U.S. Provisional Patent Application No. 61/094,595 filed Sep. 5, 2008.

### BACKGROUND OF THE INVENTION

1. Field of the Invention

This invention relates to illumination devices and, more particularly, to controlling illumination devices.

2. Description of Related Art

A wide variety of lighting control systems are currently commercially available for controlling a variety of lighting features from simple on/off switching to complex color adjustment and performance monitoring. Such systems also communicate according to a wide variety of protocols over various communication channels. As an example, a simple system could be just a triac dimmer and a single lamp. As another example, a complex system could be a hierarchical campus wide network. In such a complex system, up to 64 intelligent fluorescent lamp ballasts within a room or group of rooms could be wired together using the Digital Addressable Lighting Interface (DALI) standard, for instance, with an Ethernet enable DALI controller, which then communicates with other DALI controllers and a computer server over Ethernet within each building. At the top layer of the hierarchy, the computer servers in different buildings within a campus could communicate over the Internet using Internet Protocol (IP).

Some lighting control systems use protocols that are somewhat specific to lighting, such as 0-10V, DMX512, DALI, and Dynalite, while others use protocols that target building automation in general, such as X10, LonWorks, C-Bus, and ZigBee. Still other lighting control systems use industry standard networking protocols such as Ethernet, Wi-Fi, and HomePlug. At the campus wide level with communication over the Internet, such complex lighting control systems can also use telecom networking protocols such as SONET and ATM. All theses standards and protocols communicate at different rates, using different modulation and packetizing schemes, over various communication channels. Such channels include powerline for X10 and HomePlug, RF for ZigBee and Wi-Fi, optical fiber for SONET, and dedicated wires for most of the others including 2 wire DC for 0-10V, twisted pair for DALI and others, and CAT5 for Ethernet.

The 0-10V standard was one of the earliest and simplest lighting control signaling system, which is still supported by many fluorescent ballasts produced by companies such as GE, Philips, and Sylvania. Such ballasts produce light from an attached fluorescent lamp that is proportional to the DC voltage input to the ballast through two wires. Although simple to understand and implement, each ballast must have a dedicated cable to the system controller, which can become very expensive and cumbersome in large installations. Additionally, such a lighting control system can only control light level and cannot extract information from the ballast, such as if a bulb has burned out.

The DMX512 stands for “Digital Multiplex with 512 pieces of information” and is a standard for digital communication commonly used in theaters and production studios. DMX512 communicates over shielded twisted pair cable using EIA-485 standard voltages levels with node connected together in a daisy chain manner. Data is sent one byte per packet at 250 kbaud in a manner similar to RS232. The DMX512 protocol is popular for stage lighting due to the robustness of its cable and the relatively long communication distances.

The DALI standard, which is becoming relatively popular for commercial lighting systems, is similar to DMX512 in that various lamps can be individually controlled using a relatively low data rate digital control bus, however, there are many differences ranging from the type of communication cable and interconnections to data format and messaging requirements. While DMX512 communicates uni-directionally over shielded twisted pair cable between two nodes, DALI communicates bi-directionally over un-shielded twisted pair that can be tapped by up to 64 devices. While all DMX512 data frame comprise one start bit, 8 data bits, and two stop bits, DALI has different sized frames for communication in the different directions with both acknowledge and data bytes in one direction and no acknowledge in the other direction.

Unlike DALI, DMX512, 0-10v, and other protocols developed specifically for lighting, X10 was developed for general home automation of which lighting is an important subset. A further substantial difference is that X10 typically communicates data over the power lines that are already connected to most devices. X10 devices typically communicate one bit of information around each zero crossing of a 50 or 60 Hz AC mains cycle, by coupling bursts of a high frequency signal onto the powerline. As such, the data is very low. To compensate, the protocol is very simple in which all packets consist of an 8 bit address and a 4 bit command. Since only 16 commands are possible, functionality is limited.

HomePlug is another protocol that uses the power line for communication, however, unlike X10, which was architected for home automation, HomePlug was designed to allow products communicate with each other and the Internet through existing home electrical wiring. A variety of versions of HomePlug have been released with data rates ranging from 10 to 200 Mbit/s. HomePlug achieves such data rates using adaptive modulation and complex error correction algorithms on over a thousand Orthogonal Frequency Division Multiplexed (OFDM) sub-carriers.

Data in a HomePlug network is typically communicated in Ethernet compatible packets, which comprise of a header with about 22 bytes, the payload with up to 1500 bytes, and a CRC code with 4 bytes, however, HomePlug also provides a variety of higher level services that provide, among other things, guaranteed delivery, fixed latency, quasi-error free service, and jitter control. As such a HomePlug interface is much more complicated than is needed for simply lighting control.

Although communication over a power line is a good solution for some building networking applications, there are some drawbacks. For instance, there can be excessive attenuation between different phases of typically three phase systems, which can be overcome by active repeaters or sometimes with special capacitors. Additionally, signals can propagate through the power line between different buildings causing interference and security concerns. When appliances turn on and off significant noise is generated that can corrupt transmission. HomePlug physical layer interfaces have overcome some of such issues at the expense of complex analog and digital signal processing.

LonWorks is a building automation protocol that typically uses either twisted pair cable at 78 kbit/sec or the power line at a few kilobits per second for the communication channel. For communication over the power line, LonWorks uses dual carrier frequency operation in which messages are sent using one carrier frequency and, if a response is not received, the message is sent a second time using a second carrier frequency. More recent releases of the protocol allow IP data frames to be communicated across a LonWorks network, and a library of commands for a wide variety of appliances and functions have been and continue to be developed for a range of residential and commercial applications.

The C-Bus Protocol targets home automation systems as well as commercial lighting systems. Unlike the X10 protocol, C-Bus typically uses dedicated CAT5 cables and is considered by some to be more robust as a result. Ethernet also typically uses CAT5 cable for communicating between devices in a star topology with a router or switch at the center. Common data rates include 10, 100, and 1000 Mbit/sec, which are all deployed widely worldwide for computer networking. As mentioned previously, Ethernet data frames comprise a header of typically 22 bytes, a payload of up to 1500 bytes, and a CRC of four bytes. In many applications, the payload of an Ethernet frame is an Internet Protocol (IP) packet. Although overkill for simple lighting systems, Ethernet comprises the backbone of a variety of building lighting control networks, such as those from LumEnergi and others.

ZigBee comprises a group of high level communication protocols that typically use the IEEE 802.15.4-2003 standard for Wireless Personal Area Networks (WPANs) as the physical layer. As such, ZigBee typically uses small low power radios to communicate between appliances, light switches, consumer electronic, and other devices in a residence for instance. IEEE 802.15.4 uses either the 868, 915, or 2.4 GHz radio frequency bands. Data is direct-sequence spread spectrum coded and then Binary Phase Shift Key (BPSK) or Orthogonal Quadrature Phase Shift Key (OQPSK) modulated prior to transmission. Data is communicated in one of four different types of frames with variable data payload. Such frames include beacon frames, which specify a super-frame structure similar to that of HomePlug, data frames used for transfers of data, acknowledge frames used for confirming reception, and MAC command frame used for controlling the network. The SuperFrame structure allows certain devices guaranteed bandwidth and provides shared bandwidth for other devices. Many aspects of the network enable very low power communication with battery powered devices.

Wi-Fi or 802.11 is a very common wireless network for data communication between computers. A number of versions of the protocol including 802.11a, 802.11b, and 802.11g have been released over the years. The recent version, 802.11g, operates at the 2.4 GHz band and uses Orthogonal Frequency Division Multiplexing (OFDM) and typically achieves about 22 Mbit/sec average throughput. Similar to Ethernet, Wi-Fi frames comprise of a header, payload, and CRC. Similar to 802.15.4, Wi-Fi has a variety of different types of frames for communication management. In general, Internet Protocol (IP) and the associated Transport Control Protocol (TCP) run over Wi-Fi networks.

Although wireless protocols such as ZigBee and Wi-Fi do not need dedicated wires to communicate between devices nor do they have the limitation previously mentioned associated with power line communication, such wireless networks can be limited by congestion in increasingly crowded RF spectrum. Additionally, different countries in the world allocate spectrum differently which forces devices to sometimes operate in different frequency bands.

### SUMMARY OF THE INVENTION

An alternative physical layer communication channel and associated network protocol for lighting control among other applications have been introduced that use modulated visible light traveling through free space to communicate data. According to such protocol, all devices synchronize to the AC mains for instance and produce gaps during which messages can be sent. At other times, lamps using LEDs or any other type of light source, simply produce illumination. During the gap times some number of bytes of data can be sent from one lamp to one or more other lamps that can comprise a complete message in itself, or such data can accumulate over any number of gaps to produce much larger messages.

Using visible light to communicate between lamps and other devices in a lighting system has many advantages over wired, wireless, and powerline communication networks such as those previously described. No dedicated wires are needed, which is important especially for installation in existing buildings. The visible light spectrum is unregulated globally and does not suffer from the congestion and interference common in RF wireless communication. Electrical noise on the powerline, from appliances turning on and off for instance, does not affect communication integrity as in powerline communication protocols. No expensive and complicated analog and digital signal processing is necessary to modulate and demodulate data as in many wireless and powerline protocols. The light source needed to transmit data is necessary anyway to provide illumination, and in the case that the light source is one or more LEDs, the LEDs can operate as the light detector as well. As such, the visible light communication protocol can be implemented in an LED lamp for virtually no additional cost.

A limitation of such a visible light communication protocol is that data cannot be communicated through walls between various rooms in a building. Another limitation is that, other than the remote controller, it is difficult to cost effectively control such a visible light communication network. The invention described herein, in various embodiments, provides solutions to overcome these limitations.

In certain exemplary embodiments, an electronic device mounted to a wall in a room or held in a hand for instance, comprises a Human Machine Interface (HMI), such as a touch screen or a set of buttons dedicated to specific lighting functions or programmable to perform a variety of functions, that are illuminated by a light source. Such light source also transmits messages through free space using visible light to the lamps in such room. Such HMI could comprise an LCD panel illuminated by an LED backlight for instance for displaying information about the controls or lighting system, and either an overlaid touch screen sensor or additional pushbuttons for instance for entering information. Alternatively, the HMI could comprise just pushbuttons that are illuminated by some light source for use in the dark.

For a handheld HMI such as a smart phone or tablet computer, the display backlight could be modulated in a variety of ways including playing a video with alternating light and dark frames to produce light modulated with data. The ambient light sensor available on many handheld devices could be used to receive data transmitted through free space using visible light. An alternative light source in many handheld devices such as smart phones is the camera flash, which typically comprises one or more LEDs that can be modulated through software to transmit data through free space using visible light.

As another example, the light source in an HMI that is mounted to a wall for instance can be synchronized to the AC mains, produce communication gaps that are synchronous to the communication gaps used by such lamps in such room, and transmit data to such lamps in response to input from a user. Additionally, such HMI can have a light detector for receiving information from such lamps that is transmitted through free space using visible light. If the light source is one or more LEDs, then such LEDs can be both the light source and the light detector. In a further embodiment, the light produced by such light source in the HMI is perceived as unchanging by a user independent of whether data is being transmitted or not. This is accomplished, for instance, by producing a small amount of light continuously when data is not being transmitted and by turning this small amount of light off before or after data is transmitted at high brightness for instance. In this exemplary embodiment, control circuitry is configured to produce commands in response to input directly from a user.

In certain exemplary embodiments, an electronic device comprising an HMI with a light source and a light detector also comprises circuitry to interface to any type of data communication network typically used for lighting or building control information. Such data communication network could communicate over dedicated wires, as in Ethernet, DALI, DMX512, and others, the power line, as in X10, HomePlug, and others, RF wireless, as in ZigBee, Wi-Fi, and others, or any other communication channel including for instance fiber optic cable and wireless infra-red. Such data communication network could interface for instance to a central building controller over Ethernet or DALI, or could interface for instance to wireless communication device such as a smartphone over Wi-Fi, Bluetooth, IRDA, or any other data communication protocol supported by such wireless communication device. In some instances, such electronic device could comprise interfaces to multiple data communication networks such as Ethernet and Wi-Fi, to support lighting control systems with mixed environments.

In such an electronic device comprising an HMI that can communicate through free space using visible light, and interfaces to one or more data communication networks, control circuitry would receive input directly from the user through the HMI or from such data communication networks. Such control circuitry in response to such input produces commands encoded and transmitted according to a visible light communication protocol.

In certain exemplary embodiments, an electronic device comprises a light source for illuminating an area and transmitting data through free space using visible light, and a light detector for receiving data transmitted through free space using visible light, and comprises an interface to one or more other types of data communication networks that carry lighting control information. If one or more LEDs can operate as the light source, then such LEDs could also be operable as both the light source and the light detector. Such data communication network could communicate over any type of communication channel and communication protocol. The electronic device could function as a lamp in a ceiling for instance.

In such an electronic device, control circuitry receives input from one or more such data communication network or networks and produces commands encoded and transmitted according to a visible light communication protocol such as that described in the one or more priority applications listed herein.

### DESCRIPTION OF THE DRAWINGS

The present invention may be better understood, and its numerous objects, features, and advantages made apparent to those skilled in the art by referencing the accompanying drawings.

FIG. 1 is an exemplary block diagram of a lighting control system.

FIG. 2 is an exemplary block diagram of an electronic device that communicates with lamps through free space using visible light.

FIG. 3 is an exemplary block diagram for an electronic device that communicates with lamps through free space using visible light and with controlling devices through a Wi-Fi interface.

FIG. 4 is an exemplary diagram for the structure of a Wi-Fi data communication packet.

FIG. 5 is an exemplary diagram for a packet communicated through free space using visible light.

FIG. 6 is an exemplary drawing of an electronic device with an HMI that communicates with lamps through free space with visible light and communicates with controlling devices through Wi-Fi and Ethernet interfaces.

FIG. 7 is an exemplary block diagram of an electronic device with an HMI that communicates with lamps through free space with visible light and communicates with controlling devices through Wi-Fi and Ethernet interfaces.

FIG. 8 is an exemplary timing diagram for communicating between an HMI and lamps through free space using visible light.

The use of the same reference symbols in different drawings indicates similar or identical items. While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

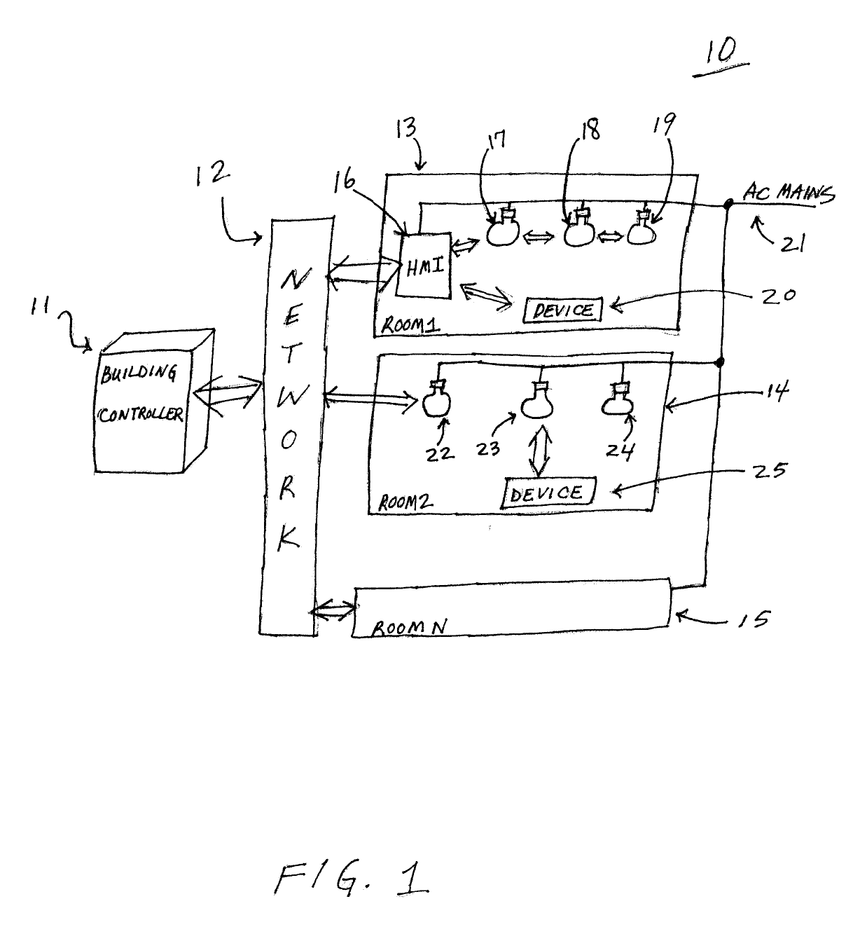

Turning now to the drawings, FIG. 1 is one example of a building lighting system 10 that comprises building controller 11 and network 12 that connects room1 13, room2 14, and roomN 15 to building controller 11. The designation room1 through roomN represent any number of rooms in a building or even multiple buildings to one of more central controllers represented by building controller 11. Within any particular room, represented by room1 13 for instance, lamps 17, 18, and 19 communicate with each other and HMI 16 through modulated visible light shown in bi-directional arrows. In this example room1 13, HMI 16 additionally interfaces between network 12, lamps 17, 18, and 19, and wireless communication device 20. Wireless communication device 20 may or may not be part of building lighting system 10, but if included, can be any type of mobile device including but not limited to mobile phones, smart phones, personal digital assistants (PDA), and mobile computers such as netbooks, notebooks, and laptops. Wireless communication device 20 could also be a stationary device such as a desktop computer, or any other type of device with any radio or infra-red frequency wireless interface including but not limited to Zigbee, Wi-Fi, and Bluetooth.

Network 12 typically might communicate according to the wired DALI or Ethernet standards, or the wireless Zigbee or Wi-Fi standards, but could communicate according to any data communication protocol using wired, wireless, powerline, fiber optic, or any other type of communication channels. Network 12 and optional wireless communication device 20 can communicate according to the same or different wireless protocols, or can communicate over different protocols using different wired or wireless communication channels.

HMI 16 represents any device that interfaces between lamps 17, 18 and 19, and network 12 that also provides a human machine interface (HMI) typically but not limited to local control of lamps 17, 18, and 19 in room1 13 for instance. HMI 16 for instance could be a device mounted in a wall within room1 13 that enables a user to control the lighting within room1 13 independent of and/or overriding commands from building controller 11. HMI 16 could be for instance a device about the size of a conventional light switch or ganged light switch with a display and touch screen that enables a user to select lighting functions from a menu or nested menus for instance. HMI 16 also for instance, could be a device with buttons that are dedicated to particular functions, such as on/off, dimming, color, timing, and other functions such as those described in the one or more priority application listed herein.

In this example FIG. 1, HMI 16 communicates with lamps 17, 18, and 19 through modulated visible light, and comprises an HMI. HMI 16 could comprise a dedicated light source and optionally an additional light detector, or according to one embodiment of the invention, could use the same light source that illuminates the HMI to communicate modulated light uni-directionally or bi-directionally with lamps 17, 18, and 19 in the example room1 13 of FIG. 1.

In order for such HMI to be visible in the dark for instance, such HMI typically comprises a backlight that illuminates various push buttons or an LCD display with overlaid touch screen sensor. Many possible HMIs are possible with the commonality that a light source is typically necessary for a user to see in at least a dark environment. Such light source typically will be an LED or array of LEDs, but could comprise any type of light source including for instance Cold Cathode Fluorescent lamps. If such light source is a CCFL or for instance a white LED with a phosphor coating, preferentially such HMI also comprises an additional photo-detector.

According to one embodiment of the invention, the light emitted from the backlight of such HMI is modulated such a way that one or more of lamps 17, 18, and 19 can detect the data represented by such modulation. HMI 16 can also receive data sent by lamps 17, 18, or 19 through the additional photo-detector, or according to another embodiment of the invention, if such backlight comprises LEDs for illumination and data transmission, and preferentially mono-chromatic LEDs such as red, green, and blue, such LEDs are also used to receive data sent by lamps 17, 18, or 19.

According to another embodiment of the invention, wireless communication device 20, which could be any type of computing device with a display such as a smart phone, PDA, or a tablet, netbook, notebook, or desktop computer, communicates directly with lamps 17, 18, and 19 through free space using visible light. As with HMI 16, the backlight for the display can be modulated to transmit data optically to lamps 17, 18, and 19, which can be accomplished in various ways including playing a video with alternating light and dark frames producing the transmitted data. The ambient light sensor available on many computing devices can be used as the light sensor to receive data. Alternatively, the camera flash, which typically comprises one or more LEDs on a smart phone for instance can also be modulated through software to transmit data to lamps 17, 18, and 19 in this example FIG. 1.

As represented by room2 14 for instance, lamp 22 can also be the interface between lamps 22, 23, and 24 that communicate between each other using visible light and network 12. As such, lamp 22 comprises a network interface capable of communicating with network 12, which could communicate according to any protocol using any communication channel including but not limited to RF wireless, wired, fiber optic, or power line. In this example room2 14, lamp 22 further comprises a light source for illumination and data transmission and a light detector for receiving data from lamps 23 and 24 in this example room2 14. In one embodiment of the invention, if the light source is one or more LEDs, then such LEDs can also operate as the light detector depending on when data is to be sent or received.

As in example room1 13 and wireless communication device 20, wireless communication device 25 in room2 14 for instance can locally control lamps 22, 23, and 24 by overriding commands from building controller 11 or can implement any functionality supported by lighting system 10. In this example room2 14, wireless communication device 25 communicates with lamp 22, which also provides the interface to network 12. As such, according to one embodiment of the invention, lamp 22 further comprises a wireless interface compatible with wireless (RF, infra-red, etc) communication device 25 and an interface compatible with network 12.

Within the example room1 13 and room2 14, lamps 17, 18, and 19, and lamps 22, 23, and 24 respectively communicate between each other using modulated visible light. When observed by the human eye, although the light is visible, such modulation of the light is typically not discernable and is typically perceived as constant and unchanging light. The maximum distance between any two lamps, for instance lamps 17 and 18, is determined by the brightness and directionality of the data transmitting lamp and the light detection sensitivity of the data receiving lamp. In this example room1 13, lamps 17 and 18 are positioned within such maximum communication distance, and lamps 17 and 19 for instance are positioned beyond such maximum communication distance. According to another embodiment of the invention lamp 18 in this example room1 13 relays messages sent through modulated visible light between lamps 17 and 19 to enable communication between large numbers of lamps that are large distances apart.

According to the invention, lamps that relay commands first receive data on a light detector and forward such input to control circuitry that regenerates commands in response to such input. For instance, commands can be directed from lamp 17 to lamp 19 only, while lamp 18 simply receives and retransmits such command along a dedicated path as in the Internet. Alternatively, messages from an example lamp 17 can be broadcast to all lamps in which lamp 18 for instance responds to such broadcast command and also retransmits such command to lamp 19 for instance. As such, commands can be sent through a network of lamps as broadcast messages or through dedicated or ad-hoc paths between particular lamps or groups of lamps. Ad-hoc paths are well known to those practicing in the field of mesh networking, which is commonly used in Zigbee wireless networks for instance.

FIG. 1 is just one example of many possible lighting control systems 10, which could comprise any number of buildings, rooms within each building, and lamps within each room, hallway, entryway, etc. Additionally, lighting control system 10 may comprise of any number of building controllers and any type or multi-types of networks between rooms. The networks 12 between rooms can communicate according to any type of protocol including standards such as Ethernet, DALI, Wi-Fi, and others that use wired, RF, power line, fiber optic, or any other type of data communication channel.

The embodiments of the invention illustrated by this example FIG. 1 include, but are not limited to, the following devices:
a. an HMI 16 that produces commands in response to input directly from a user, from a lighting control network 12, or a wireless communication device 20, and transmits such commands using the same light source that is used to illuminate the HMI;
b. a wireless communication device 20 that produces commands in response to input directly from a user and transmits such commands using the backlight or the flash of the wireless communication device 20;
c. a lamp 22 that produces commands in response to input from lighting control network 12, or wireless communication device 25 and transmits such commands using the same light source that is used for illumination;
d. a lamp 17 that produces commands in response to input from another lamp or HMI 16 and detected by the light sensor, and transmits such commands using the same light source that is used for illumination.

Preferentially, lamps and optionally HMIs communicate between each other in synchronization with the AC mains as described in one or more priority applications listed herein, however, such devices could communicate according to any communication protocol that uses visible light traveling through free space. Such communication can be between devices that are in or out of synchronization and according to any modulation technique, data rate, or distance. Likewise, any routing or mesh networking protocol can be implemented using such devices that receive and retransmit commands optically through free space. As noted herein, the term “free space” refers to communication within space, but not confined to, for example, an optical fiber. Thus, transfer of commands occurs optically, but not constrained within an optical fiber or any other type of waveguide device, yet is free and able to travel optically in any non-obstructed direction. The example of a building lighting system 10 does not limit the embodiment to a single building, but can be among several buildings or within a portion of the building. Moreover, each room shown in the lighting system 10 is configured according to one example if, for example, there are several rooms controlled by a lighting system. If the system controls only a single room, then the example in FIG. 1 would apply to different sub-regions within that room, each having a different interface to a network. Likewise, each room or sub-regions of a room can be controlled according to that shown in room1 13, room2 14, or both. Thus, the lighting system can be controlled with an HMI 16 between LEDs and network 12 or, alternatively, the HMI can essentially be the wireless communication device, e.g., device 25, and interface to the network can be achieved via lamp 22.

Accordingly, interface to the network can be achieved solely with a light source which can also function as a light detector, and the HMI can be achieved by a wireless communication device that need not be configured between the LEDs and the network. Accordingly, an electronic device is provided having both a light source and a light detector, as well as control circuitry. The electronic device can be an HMI, a lamp, or a wireless communication device, depending on the configuration shown in the examples of FIG. 1.

FIG. 2 is one example of a block diagram for an electronic device that has a light source that provides illumination and transmits data through free space, a light detector that receives data transmitted through free space, and a control circuit that produces commands transmitted by the light source in response to commands received through the light detector. Example lamps 18, 19, 23 or 24 could comprise the circuitry represented by this example FIG. 2. As such, in addition to providing general illumination, the device comprising such circuitry can receive messages sent via modulated visible light and can retransmit such information according to any pre-determined fixed routing or any ad-hoc mesh networking protocols for instance.

FIG. 2 illustrates electronic device 30 that connects to the AC mains 31 that provides power and synchronization in this example. Power supply 32 converts AC power to DC power that provides current to the LEDs 36 and voltage to the remaining circuitry in electronic device 30. Timing 33 typically comprises a phase locked loop (PLL) that locks to the AC mains 31 and provides timing information to visible light communication (VLC) network controller 34 and physical layer interface (PLI) 35. Since all the example devices 16, 17, 18, 19, 22, 23, and 24 (FIG. 1) synchronize to the same AC mains, the timing of the VLC network controllers 34 and PLIs 35 in all such example devices is substantially the same, which simplifies data communication as described in one or more priority applications listed herein.

PLI 35 typically comprises an LED driver circuit that produces typically a substantially DC current to produce illumination from LEDs 36 and modulated current to transmit data from LEDs 36. Such substantially AC and DC currents can be combined in many different ways to produce both illumination and transmit data using the same light source. Periodic time slots can be produced in synchronization with the AC mains during which the example DC current is turned off and the example AC current is turned on during gaps in which data is transmitted.

PLI 35 also typically comprises a receiver circuit that in this example FIG. 2 detects current induced in LEDs 36 while receiving data transmitted using visible light through free space. Such receiver typically converts such so called photo-current to voltage, which is then compared to a reference voltage to determine a sequence of ones and zeros sent by the transmitting device. The details of one example PLI 35 are described in one or more priority applications listed herein.

VLC network controller 34 interfaces with PLI 35 and memory 37 to receive commands transmitted using visible light through free space, to implement the necessary functionality of electronic device 30, and in some case re-transmit commands using LEDs 36 that were previously received by LEDs 36 during gap times. Commands received by the light detector, in this case LEDs 36, can be stored in memory 37 and further processed. Commands that target electronic device 30 can be interpreted by VLC network controller 34 and processed locally. For instance, the brightness or color of LEDs 36 can be adjusted by adjusting the substantially DC current applied to LEDs 36 by the driver function within PLI 35. Commands that target other or additional electronic devices can be stored in memory 37 and re-transmitted by PLI 35 and LEDs 36 during subsequent gap times for instance. Such commands can be routed through a pre-determined path, through an ad-hoc mesh network, or broadcast to all electronic devices for instance.

In this example FIG. 2, timing 33 can not only synchronize all electronic devices 30 in the network, but can also time power supply 32 to minimize noise coupling into PLI 35. As such FIG. 2 is just one example of many possible electronic devices 30 that receive commands communicated through free space using a light detector and re-transmits such commands to other electronic devices using visible light. The preferential visible light communication protocol is described in one or more priority applications listed herein, however, any visible light communication protocol and multiplexing scheme between illumination and data communication are possible. Additionally, electronic device 30 could have a variety of block diagrams different from this example FIG. 2. For instance, electronic device 30 could be DC or solar powered for instance. Likewise, any type of light source is possible including, but not limited to, fluorescent tubes, compact fluorescent lights, incandescent light, etc. In particular, electronic device 30 could comprise a light detector, such as a silicon photo-diode in addition to the light source, which in this example FIG. 2 is LEDs 36.

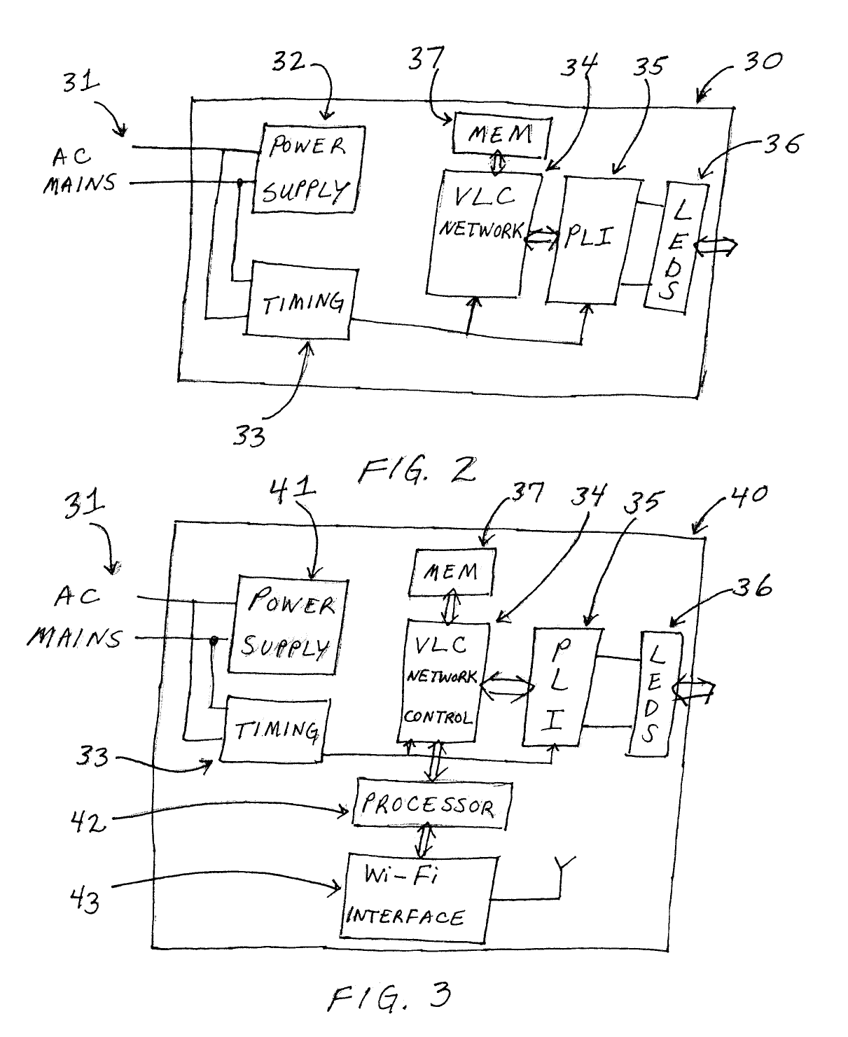

FIG. 3 is one example block diagram for electronic device 40, that can function as lamp 22 in FIG. 1, that can transmit and receive data communicated using visible light through free space, and can also communicate according to the wireless 802.11 protocol with building controller 11 and wireless communication devices 20 and 25. As in electronic device 30, electronic device 40 comprises LEDs 36, PLI 35, VLC Network Controller 34, memory 37, and timing 33. Power supply 41 may be slightly different from power supply 31 due to the additional load provided by the additional processor 42 and Wi-Fi interface 43.

In this example electronic device 40, LEDs 36 operate as both the light source and the light detector for transmitting and receiving data using visible light communicated through free space. LEDs 36 also provide illumination. Wireless 802.11 interface 43 can receive messages from smart phone 20 and 25, or building controller 11, and can forward such messages to processor 42, which can implement the control circuitry necessary to interpret or translate such messages to commands that can be transmitted through free space using visible light using LEDs 36 as the light source. Likewise, commands transmitted optically through free space can be received by LEDs 36 operating as light detectors, interpreted or translated by processor 42, and transmitted by Wi-Fi interface 43 back to wireless communication devices 20 and 25 or building controller 11. Whether or not the electronic device includes a processor and separate Wi-Fi interface, it is appreciated that electronic device 30 operates as a light source and a light detector via one or more LEDs to which it controls. Thus, the VLC network of an electronic device provides the control circuitry through the PLI to the light source and light detector dual purpose function of the LED. The controllable LED can control other LEDs within optical range, both within a bank of LEDs 36 or external to the bank of LEDs as shown by the bi-directional arrows of FIGS. 2 and 3.

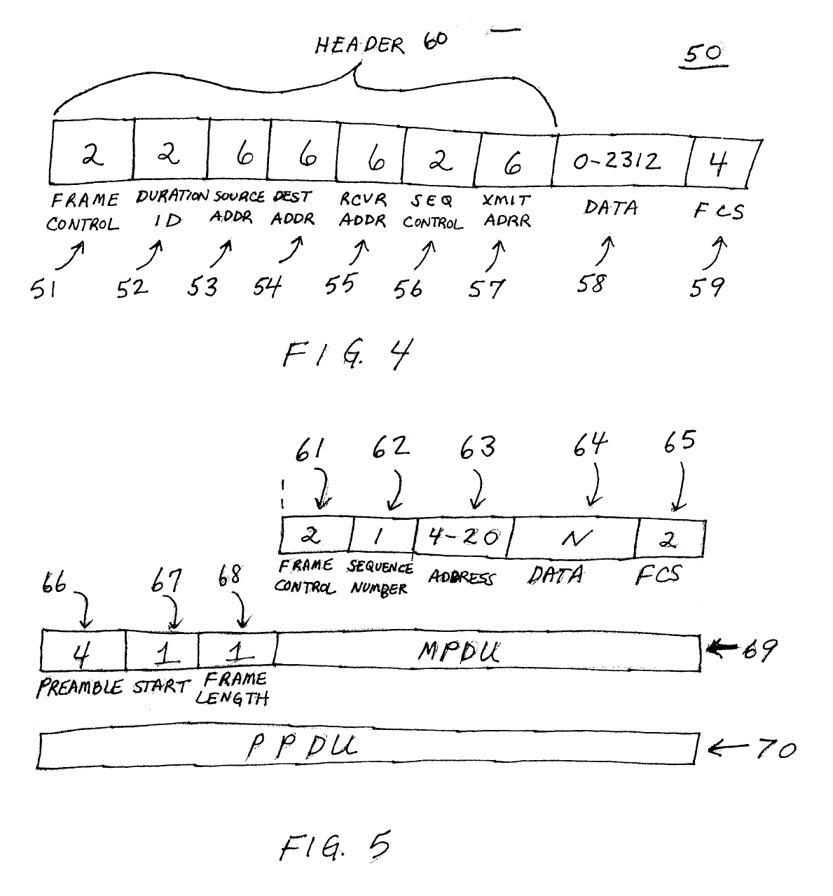

FIG. 4 illustrates the typical data frame format 50 for Wi-Fi, which comprises up to thirty bytes for header 60, zero to two thousand three hundred twelve (2312) bytes for data 58, and four bytes for frame check sequence 59. Header 60 typically comprises two bytes for frame control 51, two bytes for the duration ID 52, six bytes for source address 53, six bytes for destination address 54, six bytes for receiver address 55, two bytes for sequence control 56, and six bytes for transmitter address 57. Typically in a Wi-Fi network, data 58 comprises packets that conform to the Internet Protocol (IP), which comprise up to an additional 20 bytes of header.

FIG. 5 illustrates a possible data frame format, which is generally compatible with the ZigBee wireless protocol, for communicating with visible light that comprises Physical Protocol Data Unit (PPDU) 70, which further comprises four bytes for preamble sequence 66, one byte for start of frame delimiter 67, one byte for frame length 68, and up to 128 bytes for Mac Protocol Data Unit (MPDU) 69. MPDU 69 comprises two bytes for frame control 61, one byte for data sequence number 61, four to twenty bytes for address information 63, N bytes for data 64, and two bytes for Frame Check Sequence (FCS) 65.

In the example electronic device 40 illustrated in FIG. 3, Wi-Fi interface 43 can forward received messages conforming to the example Wi-Fi protocol illustrated in FIG. 4 to processor 42. Processor 42 interprets such messages and creates messages conforming to the example visible light communication protocol illustrated in FIG. 5. Processor 42 inputs such messages to VLC network controller 34 for transmission through PLI 35 and LEDs 36. Likewise, messages input to VLC network controller 34 through LEDs 36 and PLI 35 can be processed and transmitted through PLI 35 and LEDs 36 or forwarded to processor 42, which can interpret such messages, create messages conforming to the example Wi-Fi protocol and forward such messages to Wi-Fi interface 43 for transmission over such Wi-Fi network.

FIG. 3 is just one of many possible block diagrams for electronic device 40. For instance the light source could be a fluorescent bulb or any other type of light source. Electronic device 40 could comprise a photo-detector such as a silicon photodiode instead of using LEDs 36 as both the light source and light detector. Electronic device 40 does not need to be synchronized to the AC mains and comprise timing block 33. Many other means of synchronization are possible and communication even without synchronization is possible. Electronic device 40 could be battery or solar powered for instance and as such would have a different or no power supply 41. VLC network controller 34 and PLI 35 in this example implement the data frame format illustrated in FIG. 5, but could implement any type of communication protocol using visible light. For instance, the protocol described uses substantially the frame format as ZigBee, however, any frame format including substantially simpler versions with smaller headers are possible.

Wi-Fi interface 43 is just one example of many different network interfaces using many different types of communication channels that are possible. It is also possible to have multiple interfaces to different networks. Some other network examples include X10, DMX512, DALI, Ethernet, ZigBee, HomePlug, LonWorks, C-Bus, Dynalite, Bluetooth, and even SONET and ATM. A typical configuration for lamp 22 in FIG. 1 could include a Wi-Fi interface for communicating with a smart phone for instance for local control and an Ethernet interface for communicating with a building controller 11.

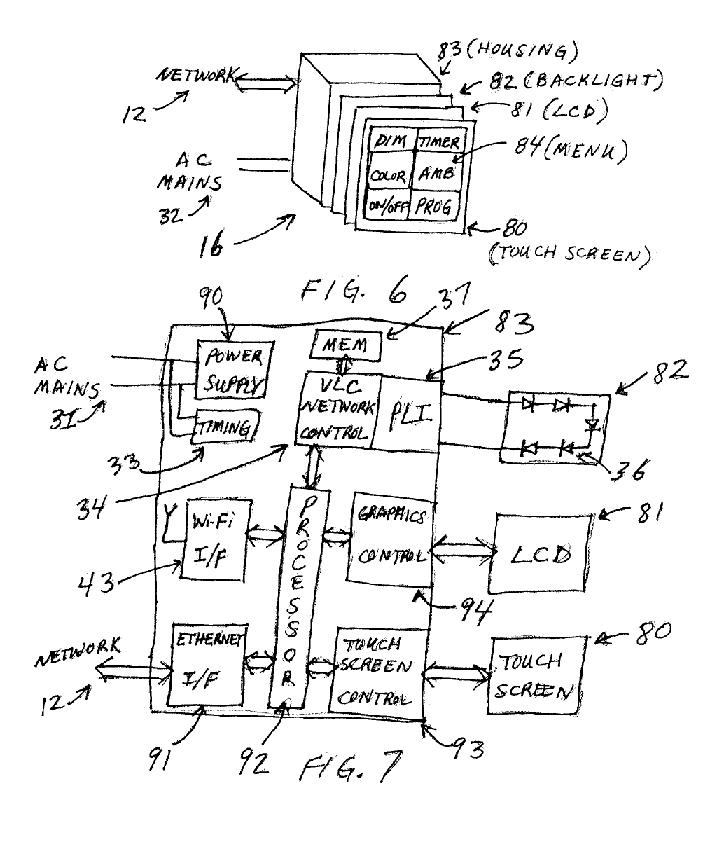

FIG. 6 provides a more detailed illustration of an electronic device operating as possible HMI 16 from FIG. 1 that interfaces to network 12, wireless communication device 20, and lamps 17, 18 and 19. In this example FIG. 6 a user can also control lamps 17, 18, and 19 within room1 13 and potentially the entire lighting system 10 by pushing regions of touch screen 80 that overlay menu 84 that is an image produced by LCD 81 and illuminated by backlight 82. The example menu 84 provides various buttons to turn lights on and off (ON/OFF), adjust brightness (DIM), change color (COLOR), set the timer (TIMER), adjust the ambient light sensor (AMB), and access advanced programming functions (PROG). In this example FIG. 6, HMI 16 is powered by the AC mains 31 and is contained within housing 83.

HMI 16 communicates with building controller 11 through network 12 according to any one of many different data communication protocols over any of a variety communication channels including but not limited to CAT5 or twisted pair cable, RF wireless, powerline or fiber optics. However, it need not communicate with device 20, HMI 16 can also optionally communicate with wireless communication device 20, which could be a smart phone, any one of many different RF, infrared, or other wireless communication protocol, including but not limited to Wi-Fi, ZigBee, Bluetooth, IRDA, or others. According to one embodiment of the invention, HMI 16 communicates with lamps 17, 18, or 19 through free space using modulated visible light that also provides illumination for HMI 16.

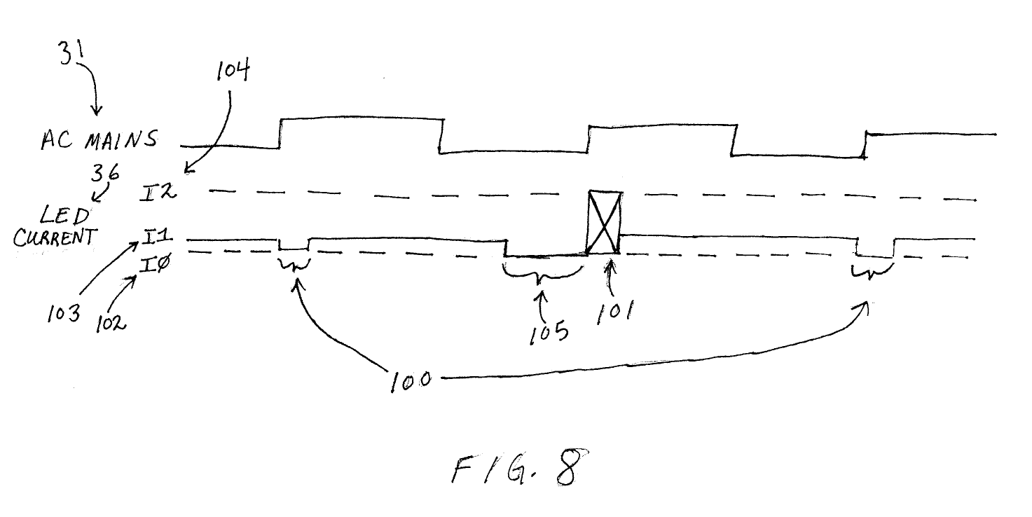

FIG. 7 is an example functional block diagram of HMI 16 that comprises touch screen 80, LCD 81, backlight 82, and housing 83. Housing 83 can comprise the same timing 33, memory 37, VLC network controller 34, PLI 35 and Wi-Fi interface 43 as illustrated in FIG. 3, and can also comprise Ethernet interface 91, touch screen controller 93, graphic controller 94, and processor 92. LEDs 36 is these examples FIG. 6 and FIG. 7 reside in backlight 82 and produce illumination for LCD 81 and HMI 16, and transmit data through free space using visible light. Additionally, LEDs 36, which in this example FIG. 7 could be red LEDs, also can operate as light detectors for receiving data transmitted through free space using visible light.

In this example FIG. 7, HMI 16 interfaces with building controller 11 according to the Ethernet protocol, which typically uses CAT5 cable as the communication channel. Messages received by Ethernet interface 91 can be forwarded to processor 92, which can implement the control circuitry necessary to interpret or translate such messages to commands that can be transmitted through free space using visible light with LEDs 36 as the light source. As in FIG. 3, messages received through Wi-Fi interface 43 can also be forwarded to processor 92 for interpretation and translation to commands that can be transmitted through free space using visible light with LEDs 36 as the light source.

In this example FIG. 7 commands transmitted optically through free space can also be received by LEDs 36 operating as light detectors, interpreted or translated by processor 42, and transmitted by Wi-Fi interface 43 back to wireless communication devices 20 or by Ethernet interface 91 to building controller 11. Likewise, processor 92 can route messages from any of Ethernet interface 91, Wi-Fi 43, and VLC network controller 34 to any other such network interface.

The protocol for communicating through free space using visible light can be the same as or different from the protocol described in one or more priority applications listed herein. In this example FIG. 7, LEDs 36 can continuously provide illumination as in a lamp and communicate for instance with lamps 17, 18, or 19, building controller 11, or wireless communication device 20 at any time. As another possibility, LEDs 36 could typically be turned off and HMI 16 could be in a low power state until a user first touches touch screen 80, after which HMI 16 powers up, illuminates LEDs 36, and enables communication.

FIG. 6 and FIG. 7 are just examples of many possible diagrams for HMI 16. For instance, HMI 16 could have any one of many possible mechanical forms with or without touch screen 80 or LCD 81. As another example, HMI 16 could comprise mechanical buttons that are illuminated from in front, behind, above, or below. As a further example, HMI 16 could comprise of an Organic LED (OLED) display instead of an LCD. Backlight 82 can be any type of light source positioned in any manner to provide illumination for HMI 16, which may have a dedicated light detector such as a silicon photodiode or use LEDs 36 for both emitting and detecting light. If HMI 16 comprises an OLED or any other type of active matrix display, such light source could be such active matrix display. Likewise, an OLED display could be the detector as well.

HMI 16 could be battery or solar powered, or powered in any other way instead of being powered by AC mains 31. HMI 16 could be synchronized to lamps 16, 17, and 18 through any one of a number means or not at all. HMI 16 could be a mobile computing device such as a smart phone, PDA, or netbook, notebook, or laptop computer, or a stationary computing device such as desktop computer or even a television.

Menu 84 and the associated functionality described is just one possibility. Any number of different menus with totally different functionality is possible. If HMI 16 does not comprise of some sort of display, then menu 84 may be replaced by pushbuttons for instance.

The block diagram for HMI 16 illustrated in FIG. 7 is just one of many possible examples. For instance, the light source could be a CCFL or even a CFL. HMI 16 could comprise an additional photodetector. Memory 37 could be a part of processor 92. Any type of network interfaces is possible to communicate with building controller 11 or wireless communication device 20. Any number of network interfaces are also possible, including none. For instance, a smart phone could communicate directly with lamps 17, 18, and 19 by modulating the backlight or the camera flash and as such would not need a Wi-Fi interface 43 or Ethernet interface 91. Ambient light sensors could be used to receive data transmitted optically.

FIG. 8 is an example timing diagram for transmitting data optically from HMI 16 in a way that minimizes or eliminates flicker. The current through LEDs 36 is typically I1 103, which should produce sufficient light to see menu 84. As described in one or more priority applications listed herein, communication gaps 100 and 101 are produced in synchronization preferentially with the AC mains 31. During gaps 100 when data is not being transmitted, the current through LEDs 36 is reduced to I0 102, which could be a low level close to or equal to zero, During gaps 101 when data is being transmitted, the current through LEDs 36 is modulated between I0 102 and I2 104. I2 104 is preferentially, but not necessarily, the highest current LEDs 36 can tolerate in order to produce the most light to communicate the maximum distance. Any data modulation technique is possible including but not limited to Non-Return to Zero (NRZ) and Bi-phase.

To minimize possible flicker produced by gaps 101 during which data is transmitted at high brightness, during time 105 preceding gap 101 the current through LEDs 36 is reduced from I1 103 to I0 102, such that the average brightness of light produced by LEDs 36 is the same whether or not data is transmitted.

FIG. 8 is just one of many possible examples of a timing diagram for transmitting data optically from HMI 16. For instance, communication gaps could occur a faster or slower rate than the AC mains, at rates totally unrelated to the AC mains, or not at all. As an example, a video could be played on a smart phone that modulates the backlight or the light from an active display such as an OLED, with light and dark frames in the video. The light from the HMI could also be allowed to flicker for instance and as such could have a significantly different timing diagram from FIG. 8.

While the invention is susceptible to various modifications and alternative forms, specific embodiments thereof are shown and described by way of example. It should be understood, however, that the drawings and detailed description thereto are not intended to limit the invention to the particular form disclosed.

1. An electronic device, comprising:
a light source configured to provide illumination and to transmit data optically through free space;
a light detector configured to receive data transmitted optically through free space; and
control circuitry configured to produce commands in response to input and to transmit said commands using the light source.

2. The electronic device as recited in claim 1, wherein the electronic device transmits data in synchronization with an AC mains.

3. The electronic device as recited in claim 1, wherein the light source is one or more LEDs.

4. The electronic device as recited claim 3, wherein the light detector is one or more of the LEDs used as the light source.

5. The electronic device as recited in claim 1, wherein the light source is a fluorescent bulb.

6. The electronic device as recited in claim 1, wherein the electronic device further comprises a human machine interface (HMI), and the light source illuminates the HMI.

7. The electronic device as recited in claim 1, wherein the electronic device comprises a handheld communication device, and wherein the data is transmitted by modulating the light from a camera flash or a display of the handheld communication device.

8. The electronic device as recited in claim 7, wherein light from the display is modulated by light and dark frames of a video.

9. The electronic device as recited in claim 6, wherein the control circuitry produces said commands in response to input from the HMI.

10. The electronic device as recited in claim 1, wherein the electronic device further comprises a network interface, and wherein the control circuitry produces said commands in response to input from the network interface.

11. The electronic device as recited in claim 10, wherein the network interface is connected to a cable over which data is communicated, and wherein the cable communicates data according to a protocol selected from a group consisting of DALI and Ethernet.

12. The electronic device as recited in claim 10, wherein the network interface communicates data using radio waves, and wherein the radio waves communicate data according to a protocol selected from a group consisting of Zigbee, IEEE802.11, and Bluetooth.

13. The electronic device as recited in claim 1, wherein the control circuitry produces said commands in response to input from the light detector.

14. The electronic device as recited in claim 13, wherein the input from the light detector comprises data communicated according to the same protocol as the data transmitted by the light source.

15. The electronic device as recited in claim 1, wherein the control circuitry is configured to transmit the same command through the light source that is received by the light detector to enable commands to be communicated to other electronic devices in a mesh network.

16. A lighting system comprising:
a light source configured to receive commands communicated optically through free space;
a building controller configured to control the lighting system; and
a human machine interface (HMI) configured to receive commands from the building controller and to forward said commands to the light source optically through free space.

17. The lighting system as recited in claim 16, wherein the building controller communicates with the HMI over copper wire or an RF communication channel.

18. The lighting system as recited in claim 16, wherein the light source and the HMI communicate in synchronization with each other.

19. The lighting system as recited in claim 18, wherein the light source and the HMI communicate in synchronization with an AC mains.

20. The lighting system as recited in claim 16, wherein the illumination device uses at least one LED to both illuminate and to receive commands communicated optically through free space.

21. The lighting system as recited in claim 16, wherein the building controller communicates with the HMI using the DALI protocol.

22. The lighting system as recited in claim 16, wherein the building controller communicates with the HMI using Ethernet.

23. The lighting system as recited in claim 16, wherein the building controller communicates with the HMI using Zigbee, IEEE 802.11, or Bluetooth.

24. An electronic device, comprising:
a display interface to enable a user to provide input to the electronic device;
control circuitry configured to produce commands in response to such input; and
a light source configured to provide illumination of the display and to transmit commands optically through free space.

25. The electronic device as recited in claim 24, wherein the light source illuminates the display and transmits said commands by modulating visible light from the light source in response to said input.

26. A method to transmit data from a light source, comprising;
configuring the light source to produce a particular average output light level;
controlling the light source to emit at least two different output light levels during a period of time when transmitting data;
reducing the output light level for a period of time before or after the period of time when transmitting data.

27. The method as recited in claim 26, further comprising reducing the output light level for the period of time before or after the period of time when transmitting data, such that the average light level produced over such period of time and the period of time when transmitting data is substantially equal to the particular average output light level.

28. The method as recited in claim 26, further comprising:
providing communication gaps at regular, periodic intervals of each cycle of an AC mains;
restricting the transmitting data solely within a subset of said communication gaps; and
immediately preceding the subset of said communications gaps, reducing current through the light source.

29. The method as recited in claim 28, further comprising modulating the light source within the subset of said communication gaps.

30. The method as recited in claim 29, further comprising increasing current through the light source within the subset of said communication gaps.

31. The method as recited in claim 28, further comprising restricting the time duration of said communication gaps to be less than one quarter of each cycle of said AC mains.
